(19) United States
(12) Patent Application Publication
(10) Pub. No.: US 2009/0222365 A1
(43) Pub. Date: Sep. 3, 2009

(54) Community-Based Transaction Categorization

(76) Inventors: Joseph A. McGlynn, Highlands Ranch, CO (US); Conor Keane, Englewood, CO (US)

Correspondence Address: HENSLEY KIM & HOLZER, LLC, 1660 LINCOLN STREET, SUITE 3000, DENVER, CO, 80264, US

(21) Appl. No.: 12/396,260

(22) Filed: Mar. 2, 2009

Related U.S. Application Data
(63) Continuation-in-part of application No. 12/352,012, filed on Jan. 12, 2009.
(60) Provisional application No. 61/032,578, filed on Feb. 29, 2008.

(51) Int. Cl. G06Q 10/00; G06Q 40/00

(52) U.S. Cl. 705/30

(57) ABSTRACT

Presently disclosed is a system and method for community-based transaction categorization that utilizes previous categorizations of transactions by members of a community of users to categorize a new transaction for an individual member of the community. Each manual categorization of a transaction by a user within the community may be used to generate a community designation rule. Then each community designation rule may be used to categorize transactions of another user within the community. More specifically, when a user within a community manually categorizes a transaction, an individual rule applicable to all the user's transactions with similar attributes is generated. If the individual rule meets certain criteria, the individual rule becomes a community rule. The community rule is then applicable to all users within the community having transactions with similar attributes.

### CROSS REFERENCE

This application is a continuation-in-part of co-pending U.S. application Ser. No. 12/352,012 filed Jan. 12, 2009 entitled “System and Method for Attribute-Based Transaction Categorization, which in turn claims the benefit of U.S. Provisional Application No. 61/032,578 filed Feb. 29, 2008 entitled “System and Method for Community-Based Transaction Categorization,” which is hereby incorporated by reference in its entirety.

### BACKGROUND

A major challenge in helping users get value from Personal Financial Management (PFM) systems is reducing or overcoming the administrative effort involved in obtaining meaningful financial advice from the PFM system. Today's popular PFM applications require extensive user effort to set up the PFM system and continued user effort to ensure day to day user spending is recorded and analyzed accurately.

Conventional PFM systems utilizing transaction categorization typically allow the user to manually assign a category to each transaction for budget analysis. Some conventional PFM systems store the categorization that the user associated with a merchant and apply that same categorization to future transactions with that same merchant. Similarly, conventional PFM systems typically allow the user to manually edit a merchant name to be used later for budget analysis.

Further, some conventional PFM systems utilize a database that stores common category and/or merchant name associations for known merchants. Commonly, these associations are community rules that link one name or attribute to one category for a community of users. These systems apply those associations by default to all the users of the community unless a user specifies otherwise. Further, the conventional community rules are typically updated manually by a system administrator. The system administrator may decide that a common category and/or merchant name association for a known merchant should be added.

### SUMMARY

Presently disclosed is a system and method for community-based transaction categorization (hereinafter “transaction categorization”) that utilizes previous categorizations of transactions by members of a community of users to categorize a new transaction for an individual member of the community. Each manual categorization of a transaction by a user within the community may be used to generate a community designation rule. Then each community designation rule may be used to categorize transactions of another user within the community.

Further, the transaction categorization system and method may be attribute-based. Using transaction designation attributes other than or in addition to a payee name (e.g., a merchant name) may provide reduced user effort and improved accuracy in the categorization of transactions. Further, the transaction categorization system may retroactively re-categorize and/or re-name previously received and/or categorized transactions based on transaction categorizations of subsequently received and/or categorized transactions.

In one implementation, transaction categorization collects transaction attributes and uses them to take much of the user effort out of managing user finances by automatically categorizing recognized transactions. More specifically, the transaction categorization system has access to designation rules associating attributes of transactions other than or in addition to payee name with transaction designations. The transaction designations may include categories and transaction names. The transaction categorization system uses these designation rules to automatically associate designations to individual transactions.

In one implementation, the transaction categorization system may assign match scores based on the number and/or type of designation attributes that match rules for associating a designation to a transaction. If a match score exceeds a predetermined threshold and/or is greater than other match scores (i.e. the best match score), the transaction is automatically designated. Otherwise, the user may manually designate the transaction.

In another implementation, the user may manually generate rules, categories, and/or transaction names for transaction designation. Further, the user may manually designate transactions and the transaction categorization system can use the manually designated transactions to generate new designation rules. Still further, the transaction categorization system can retroactively re-categorize and/or re-name previous transactions based on new rules generated by the transaction categorization system based in turn on manually designated transactions.

In yet another implementation, the designation rules are separated in two groups, community rules and individual rules. When a user within a community manually categorizes a transaction, an individual rule applicable to all the user's transactions with similar attributes is generated. If the individual rule meets criteria described below in detail, the individual rule becomes a community rule. The community rule is then applicable to all users within the community having transactions with similar attributes.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following detailed description.

### BRIEF DESCRIPTION OF THE DRAWINGS

FIG. 1 illustrates an example community-based transaction categorization system operating over a network in accordance with one implementation of the presently disclosed technology.

FIG. 2 illustrates a transaction categorization server for an example community-based transaction categorization system in accordance with one implementation of the presently disclosed technology.

FIG. 3 is a community-based transaction categorization flowchart illustrating an example method for associating a transaction designation according to one implementation of the presently disclosed technology.

FIG. 4 is a community-based transaction categorization flowchart illustrating an example method for generating new designation rules according to one implementation of the presently disclosed technology.

FIG. 5 is a community-based transaction categorization flowchart illustrating an example method for associating a transaction designation using individual rules and community rules according to one implementation of the presently disclosed technology.

FIGS. 6-8 are screenshots of example user interfaces for use in a community-based transaction categorization system according to various implementations of the presently disclosed technology.

FIG. 9 illustrates a general purpose computer upon which components and functionality of example implementations may be implemented.

### DETAILED DESCRIPTION

Community-based transaction categorization (hereinafter “transaction categorization”) takes much of the user effort out of personal financial management by automatically categorizing transactions for a user. From the moment the user accesses the transaction categorization system; his/her effort is focused on understanding their budget, reviewing their spending, making decisions on how to meet goals, and determining whether any changes should be made in their behavior manually categorizing each of his/her transactions. With implementations of the presently disclosed technology, users have more time to understand their finances and use the benefits of a corresponding Personal Financial Management (PFM) application (e.g., budgeting, financial analysis, and decision making). As a result, the PFM application accordingly to the presently disclosed technology is more beneficial to the user than a conventional PFM application.

Transaction categorization, referred to throughout this disclosure, contemplates static designations (e.g., the designation of financial categories to transactions and designation of abbreviated or customized names for transactions with a common payee). Further, transaction designation also contemplates dynamic designations, designations that alter the characteristics of a transaction attribute (e.g., truncation of various features of a payee field of a transaction and payee field feature look-up in a feature database based on transaction attributes). Further, any other designations that a user may make or want a PFM system to make to help organize and analyze the user's financial transactions are contemplated herein.

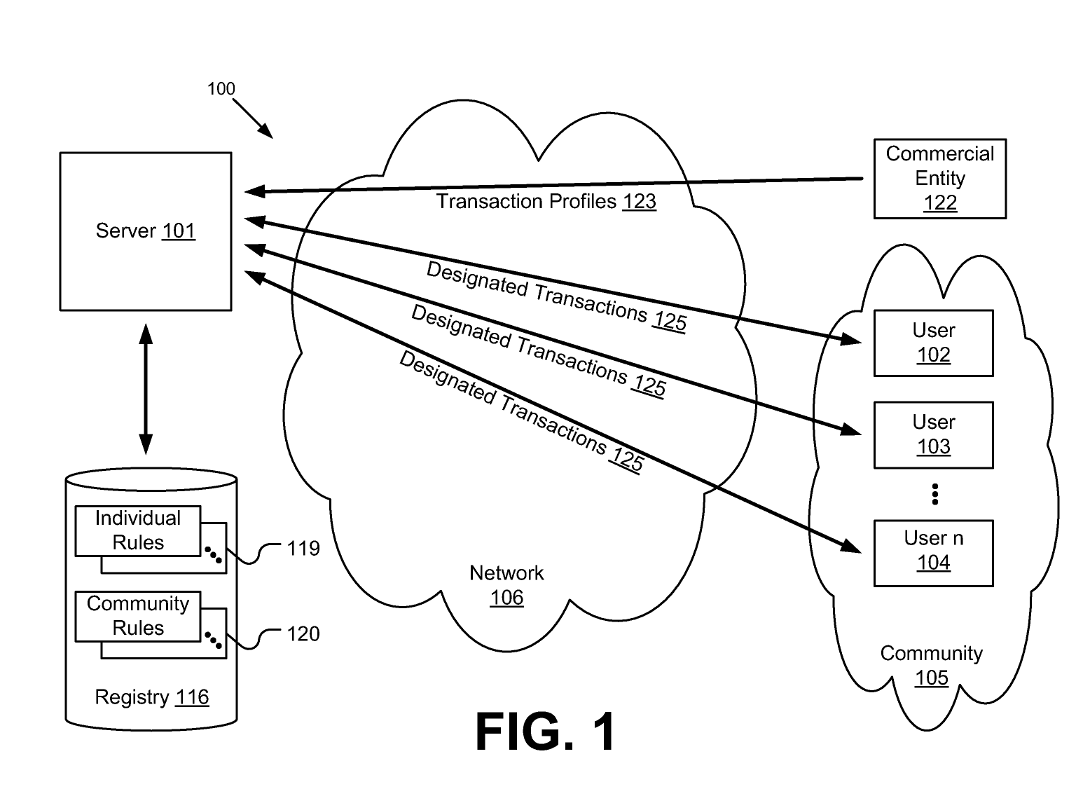

FIG. 1 illustrates an example transaction categorization system 100 operating over a network 106 in accordance with one implementation of the presently disclosed technology. A commercial entity 122 (e.g., banks, stores, restaurants, etc.) is in communication with and submits transaction profiles 123 associated with one or more users 102, 103, and, 104 of a community 105 to a transaction categorization server 101 via a wireline connection, wireless connection, or any combination thereof. Transaction profiles 123 include transaction attributes describing a transaction, including, but not limited to, payee name, transaction description, transaction date, transaction amount, transaction type code, account type, payment method, recurrence period, recurrence time, demographic information, match count, and select count.

In one implementation, the server 101 periodically accesses a server associated with the commercial entity 122, the server 101 then downloads the transaction profiles 123 associated with the one or more users 102, 103, and 104 from the commercial entity 122. Individual rules 119 and Community rules 120 stored in a registry 116 are applied to designate the transaction profiles 123, The results are compiled in a designated transactions report and sent to the users 102, 103, and, 104. The designated transactions report contains a grouping of designated transactions 125 for a specific user (e.g., user 102) of the community 105. Optionally, user 102 may then respond to the server 101 with transaction report corrections containing revised transaction designations if the designated transactions report is incomplete or incorrect.

The transaction categorization server 101 is in operable communication with a data store, such as a registry 116, which includes one or more designation rules (i.e. individual rules 119 and community rules 120). The individual rules 119 are each applicable to a specific user (e.g., user 102) of the community 105. The community rules 120 are each applicable to two or more users of the community 105.

The designation rules are associated with designations and contain one or more transaction attributes that are compared with one or more transaction attributes in the transaction profiles 123. Each designation rule is associated with one designation. The transaction categorization system 100 can compute match scores for each combination of transaction profile 123 and designation rule based on the number of transaction attributes that match. If a designation rule contains multiple transaction attributes, application of the designation rule may yield multiple attribute scores. The multiple attribute scores may be summed or averaged to yield an overall match score for the transaction.

The individual rules 119 are first applied to the transaction profiles 123 of the specific user 102. If one or more of the individual rules 119 yields a match score that meets a match criterion (e.g., exceeds a threshold) for a specific transaction, the individual rule 119 with the highest match score will be applied and the transaction will be designated according to the individual rule 1 19. If none of the individual rules 119 yields a match score that meets the match criterion for the transaction, the community rules 120 are applied. If one or more of the community rules 120 yields a match score that meets the match criterion, the community rule 120 with the highest match score will be applied and the transaction will be designated according to the community rule 120.

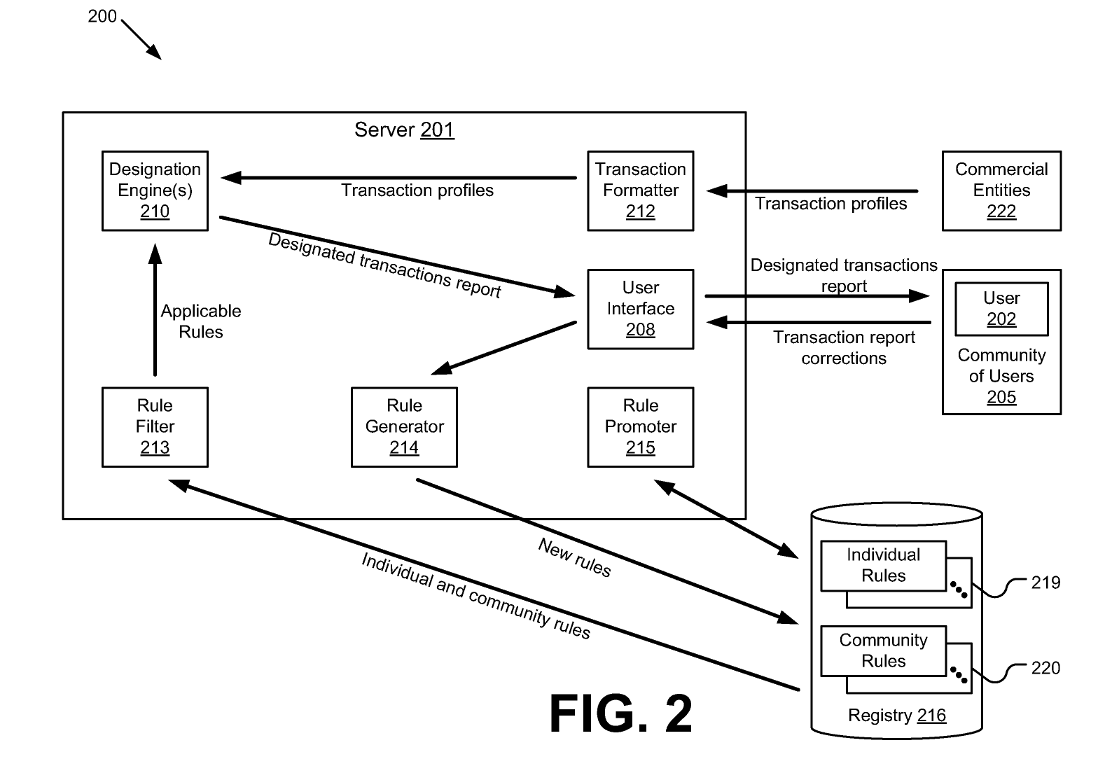

The transaction categorization server 101 repeats this process for all available transactions associated with user 102 and generates and sends to user 102 a designated transactions report compiling all the designated transactions 125 for user 102. The transaction categorization server 101 may repeat this process for other users (e.g., user 103 through user n 104) within the community 105 as well. Transactions where no individual rule 119 or community rule 120 yields a match score that meets the match criteria or in transactions where multiple individual rules 119 or multiple community rules 120 yield equal (or in some implementations, nearly equal) values are designated as “unknown” in the designated transactions report and are left for the user 102 to manually designate. Manual transaction designations may be incorporated as new community rules 120 as described with more detail below with reference to FIG. 2. Alternatively, the transaction categorization system 100 may provisionally designate unknown transactions but flag them for the user 102 to review later. The designated transactions report is sent to the user 102 over the network 106 via wireline connection, wireless connection, or any combination thereof. The transaction designations may be categories, payee names, or any other designations that a user may make or want a PFM system to make to help organize and analyze the user's financial transactions.

The user 102 may then review the designated transactions report and optionally provide transaction report corrections back to the server 101. In one implementation, the designated transactions report may not contain all of the user's transactions. The user 102 may send the server 101 additional transaction profiles 123 as transaction report corrections for designation and inclusion in the designated transactions report.

In another implementation, one or more transactions in the designated transactions report may be lacking designation or mis-designated. The user 102 may send the transaction categorization server 101 corrected designations for mis-designated transactions and/or new designations for un-designated or designation “unknown” transactions. The transaction categorization system 100 uses the corrected and/or new designations to create new individual rules 119 or update existing individual rules 119 to correspond with the designation preferences of user 102. Further, if the new or updated individual rules 119 meet certain criteria detailed below, they become promotable to community rules 120. The corrected and/or new designations may be categories, payee names, or any other designations that a user may make or want a PFM system to make to help organize and analyze the user's financial transactions.

In yet another implementation, the transaction categorization system 100 may retroactively update previously designated transactions to be consistent with the user's corrected and/or new designations and corresponding corrected and/or new individual rules 119. Further, if the user's corrected and/or new individual rules 119 are promoted to community rules 120, the transaction categorization system 100 may retroactively update previously designated transactions in transaction designation reports to other users of the community 105. This updating may be accomplished automatically or via a user prompt. The retroactively updated designations may be categories, payee names, or any other designations that a user may make or want a PFM system to make to help organize and analyze the user's financial transactions.

In yet another implementation, the user 102 proposes new designations and/or individual rules 119 associated with the new designations to be included in the transaction categorization system 100. The transaction categorization system 100 either automatically incorporates the user's new individual rules 119 and/or new designations or provides a reviewing process to test and approve the user's new individual rules 119 and/or new designations. The transaction categorization system 100 may also provide a separate reviewing process to test and approve the user's new individual rules 119 and/or new designations for promotion to community rules 120 and/or designations. Further, if the user 102 merely provides a new designation without a corresponding individual rule 119, the transaction categorization system 100 may generate individual rules 119 for use with the new designation.

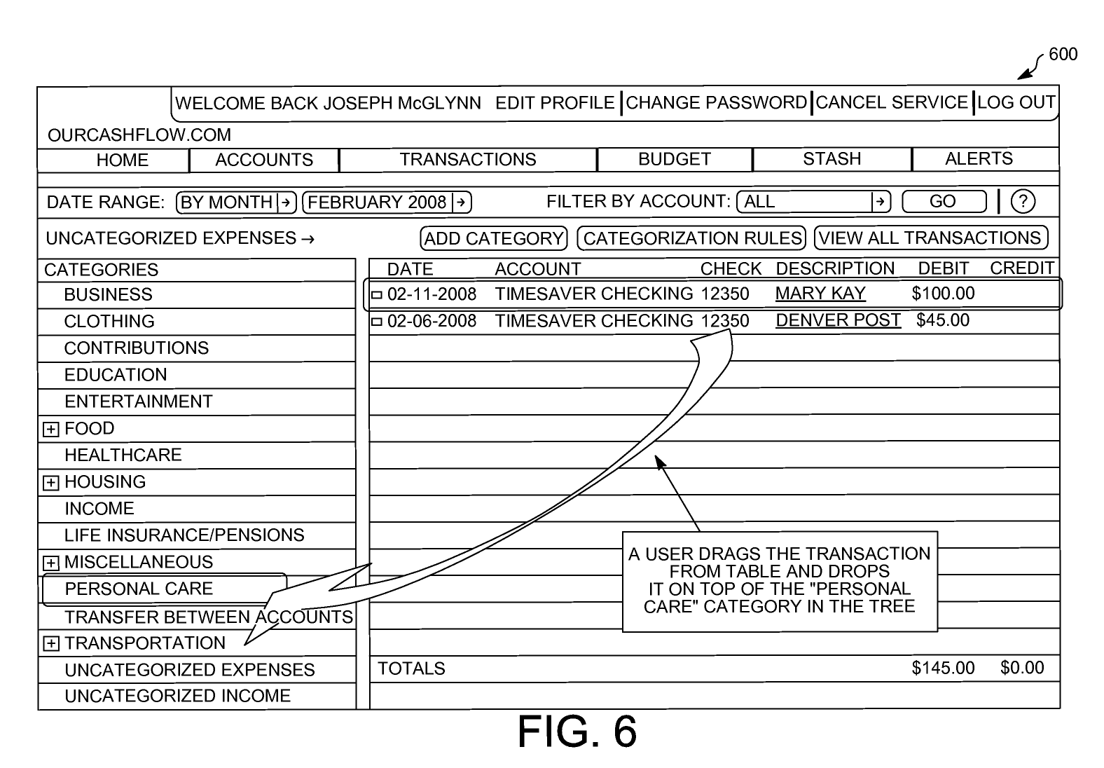

FIG. 2 illustrates a transaction categorization server 201 for an example community-based transaction categorization system 200 in accordance with one implementation of the presently disclosed technology. The server 201 includes a user interface 208, one or more designation engines 210, a transaction formatter 212, a rule filter 213, a rule generator 214, and a rule promoter 215. Individual users within a community of users 205, one or more commercial entities 222, and a data store (e.g., registry 216) are connected to the server 201 via network connections that may be wireline, wireless, or any combination thereof. Each individual user interacts with the transaction categorization system 200 via the user interface 208. In one implementation, each individual user has a unique user interface 208 for interfacing with the server 201. Graphical user interfaces such as those shown in the screenshots of FIGS. 6-8 can be presented via user interfaces 208.

In one implementations, one or more commercial entities 222 (e.g., banks, stores, restaurants, etc.) are in communication with the server 201. Commercial entities 222 may be sources of transaction profiles that can be submitted to the server 201. Individual users may also submit transaction profiles to the server 201. Transaction profiles include transaction attributes describing a transaction, including, but not limited to, payee name, transaction description, transaction date, transaction amount, transaction type code, account type, payment method, recurrence period, recurrence time, demographic information, match count, and select count. The transaction formatter 212 formats incoming transaction profiles from the commercial entities 222 and/or individual users and outputs a corresponding series of undesignated transactions to the designation engine 210. In one implementation, the transaction formatter 212 derives transaction attributes based on the transaction profiles.

The designation engine 210 correlates incoming transaction profiles with applicable designation rules fed from the rule filter 213. The rule filter 213 has access to all individual designation rules 219 and community designation rules 220 within the registry 216, but filters out designation rules that are not applicable to the incoming transaction profiles. In one implementation, the rule filter 213 filters out any individual rules 219 that do not correspond to a specific user associated with the incoming transaction profiles. In another implementation, the rule filter 213 filters out all the community rules 220 so that the individual rules 219 are applied to the incoming transaction profiles first. Then the rule filter 213 filters out all the individual rules 219 so that only the community rules 220 are applied to the transaction profiles. In additional implementation, the rule filter 213 filters out inapplicable designation rules based on transaction attributes of the transaction profiles.

In various implementations, correlating a transaction profile with an applicable designation rule involves determining the degree to which the associated transaction profile corresponds to the designation rule. In one implementation, a transaction profile is correlated with a designation rule by correlating one or more of the transaction attributes with data in the designation rule to yield attribute scores associated with each correlated transaction attribute. The attribute scores may be summed or averaged to generate an overall transaction match score. As a result, each match score is associated with a specific transaction and one of the designation rules.

If the transaction match score for a transaction profile exceeds a threshold and/or is greater than other transaction match scores, the designation engine 210 designates the transaction according to the corresponding designation rule. Similarly, if all transaction match scores for the transaction profile fail to exceed the threshold and/or multiple match scores exceed the threshold by an equal (or in some implementations, nearly equal) amount, the designation engine 210 designates the transaction as “unknown.” This process is applied to all the transaction profiles associated with a specific user (e.g., user 202). The designation engine 210 prepares a designated transactions report containing all the designated transactions (including the “unknown” transactions) to the user 202 via the user interface 208.

Transactions designated “unknown” within the designated transactions report may be presented to the user 202 for manual designation and learning. The designation engine 210 may select a narrowed group of designation suggestions for the transaction. For example, one user within the community 205 may shop SEARS primarily for clothing, while another user within the community 205 shops SEARS® for power tools. In this case, the designation engine 210 will suggest both designations to the user 202 and the rule generator 214 will learn which designation to use on future user 202 SEARS transactions based on the manual designation of the transaction. The rule generator 214 generates individual designation rules 219 based on manual transaction designation by a user. The rule generator 214 monitors manual transaction designations of users to “learn” user-preferred individual rules 219 that associate transaction attributes with specific transaction designations.

Some implementations of the transaction categorization system 200 may be viewed as “learning” designation strategies from users within the community 205. Further, learned strategies can be applied to future transactions of the user (e.g. user 202) who created the strategy. Designation strategies can be automatically applied to transactions without requiring manual user designation. Alternatively or in addition, user 202 may be prompted with a number of designations having matching (or nearly matching) scores according to individual rules 219. The user 202 may be prompted to manually select from the designations having matching scores.

According to one such implementation of the presently disclosed technology that “learns” designation strategies from users within the community 205; keywords and other transaction characteristics are “tagged” in each transaction profile to create an “attribute set” for each transaction. The transaction categorization system 200 then “learns” how the attribute sets are designated. As the users within the community 205 manually designate transactions, the rule generator 214 receives the manual designations and learns “target designations” for transactions with certain attributes. The rule generator 214 then generates new individual rules 219 based on the target designations and sends the new individual rules 219 to the registry 216. This trains the transaction categorization system 200, allowing it to very quickly create new individual rules 219.

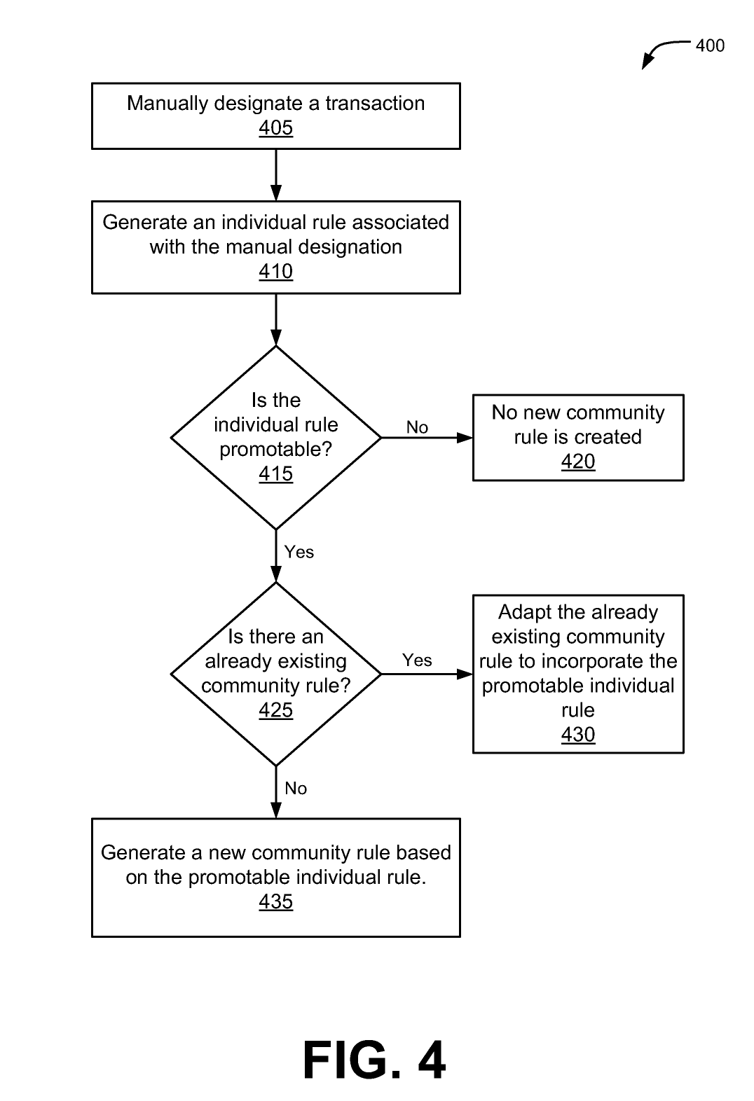

In one implementation, newly generated individual rules apply only to the user that made the manual designation. The rule promoter 215 monitors the newly generated individual rules 219 and determines if each individual rule 219 is promotable to a community rule 220 based on criteria discussed in detail with respect to FIG. 4. If a new individual rule 219 is promotable, it is compared to the existing community rules 220 to see if the new individual rule 219 corresponds to an existing community rule 220. If there is a sufficient match, a relevance factor of the existing community rule 220 is increased. If there is not a sufficient match to an existing community rule 220, the new individual rule 219 is promoted to a new community rule 220.

The operating environments 100 and 200 shown in FIGS. 1 and 2 are simplified from actual operating environments for ease of illustration. In an actual networked environment there may be many users and/or commercial entities. In addition, the network 106 and/or communities 105, 205 may be composed of many networks and/or sub-networks. For example, the network 106 and/or communities 105, 205 may represent the Internet which includes numerous sub-networks. The network connections between the transaction categorization server 101, 201 and the users and/or commercial entities may be virtual private networks. Generally the connections are secure connections using any secure communication protocol known in the art.

Using common attributes of transactions such as, but not limited to, payee name, transaction description, transaction date, transaction amount, transaction type code, account type, payment method, recurrence period, recurrence time, demographic information, match count, and select count, the transaction categorization system 100, 200 can quickly learn how to designate transactions for spending analysis. The transaction categorization system 100, 200 automatically creates individual rules 119, 219 for a user based on the user's manual designations as well as utilizing individual rules 219 and/or community rules 120, 220 defined by a system administrator.

Statistical categorization and machine learning techniques have been applied to unstructured data categorization, including multivariate regression models, Bayesian models, decision trees, neural networks, and symbolic rule learning. Most recently, Support Vector Machines (SVMs) for classification have been shown to learn faster and categorize more accurately than earlier methods. Some implementations described herein use an adapted version of SVM for providing transaction categorization functionality. Experiments conducted separately by MICROSOFT¹ and Joachims² found that SVM's categorized even the simplest document representation (using individual words delimited by white spaces with no stemming) accurately for up to 98% of the documents presented. The inventors have seen similar results in initial tests with an implementation of the presently disclosed transaction categorization system. Other implementations do not use an SVM, but rather a pattern matching-based approach. ¹Dumas et al for Microsoft, Inductive Learning Algorithms and Representations for Text Categorization, 1998.²Joachims, T. Text categorization with support vector machines: Learning with many relevant features. In Proceedings 10ₜₕ European Conference on Machine Learning (ECML), Springer Verlag, 1998.

Implementations of a method and system for transaction categorization may use any existing and emerging unstructured data categorization approaches that support tasks as diverse as real-time sorting of new reports, spam filtering, hand writing recognition, structured search, and image classification. These data categorization approaches may be adopted and modified for financial transactions designation according to the presently disclosed technology. Community-based designation—the assignment of unstructured data and natural language text to one or more predefined designations based on the content—is a key component in taking the effort out of PFM administration according to the presently disclosed technology.

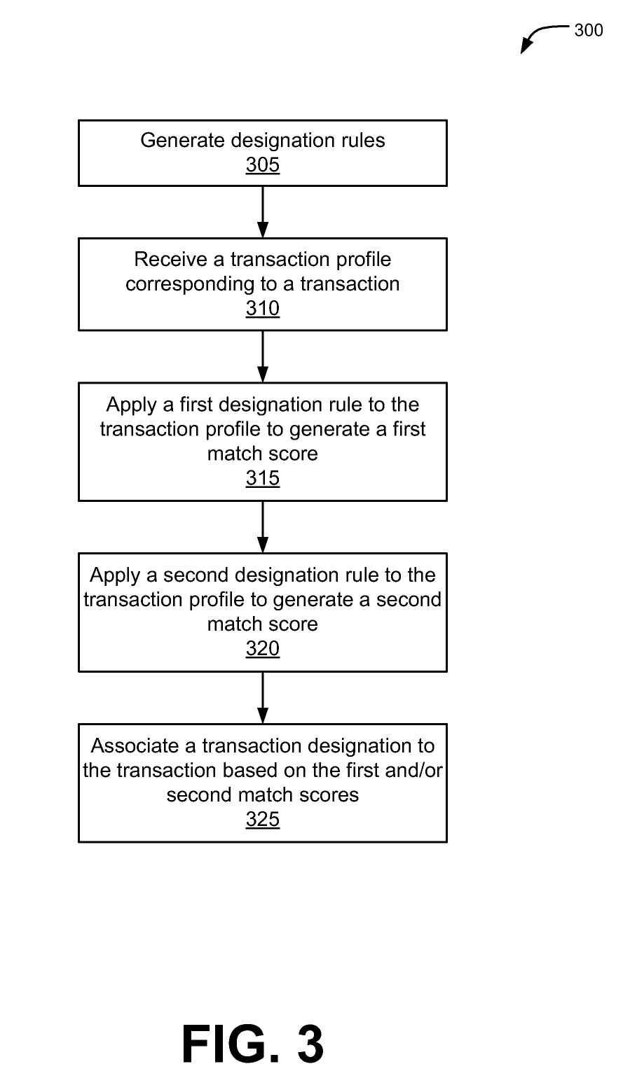

FIG. 3 is a community-based transaction categorization flowchart 300 illustrating a method for associating a transaction designation according to one implementation. The transaction categorization system first generates a set of designation rules relating transaction attributes to a plurality of financial transaction designations 305. The designation rules may be generated by a system administrator based on transaction attributes common to a transaction designation. Alternatively, the designation rules may be generated by a user and incorporated into the transaction categorization system automatically or submitted to a system administrator for approval. In one implementation, the system administrator may automatically incorporate individual designation rules and utilize an approval and/or testing process before promoting the individual rules to community rules. See FIG. 4 for details regarding the promotion of individual rules to community rules.

In another implementation, the user may manually designate a transaction. The system administrator can capture attributes of the manually designated transaction and generate a designation rule associating one or more of the transaction attributes with the identified designation. Further, operations performed by the system administrator may alternatively be performed within the transaction categorization system by executing a series of logic functions and thresholds to test the new designation rules.

Next, the transaction categorization system receives a transaction profile corresponding to a transaction 310. The transaction profile includes transaction attributes, including, but not limited to payee name, transaction description, transaction date, transaction amount, transaction type code, account type, payment method, recurrence period, recurrence time, demographic information, match count, and select count. The transaction profile may be sent to the transaction categorization system from a commercial entity (e.g., a bank, store, restaurant, etc.) or a user of the transaction categorization system.

The transaction categorization system applies a first designation rule to the transaction profile to generate a first match score 315. More specifically, applying the first designation rule may include generating one or more transaction attribute scores, each transaction attribute score being associated with an attribute of the transaction, and combining the transaction attribute scores to generate the first match score. Generating the first match score may include weighting each of the transaction attribute scores with a weight factor associated with the corresponding attribute and/or the degree to which each attribute matches a corresponding field of the first designation rule. Further, determining the first match score may include finding transaction attributes in the transaction profile that match at least one transaction attribute in the first designation rule. Similarly, the transaction categorization system may then apply a second designation rule to the transaction profile to generate a second match score 320.

Finally, the transaction categorization system associates a transaction designation to the transaction based on the first and/or second match scores 325. In one implementation, there is only one designation rule applied and thus only one match score calculated for a transaction. The transaction categorization system may compare the match score with a match criterion (such as a value threshold) to determine if the match is sufficient to associate a transaction designation to the transaction.

The first and second designation rules may be individual rules or community rules. In one implementation, only the applicable individual rules are applied to designate the transaction because the individual rules are customized to the individual user and are likely to result in a more accurate designation of the transaction profile. The applicable community rules are then applied only if no application of an individual rule results in a match score that meets or exceeds the match criterion.

In another implementation where the first and second designation rules are naming rules and the transaction designation is a payee name, the transaction categorization system can replace the contents of the payee field of the transaction profile with the payee name as specified by the first and/or second naming rule. In another implementation, the content of the payee field of an incoming transaction is blank and filled in with the payee name as specified by the first and/or second naming rule.

In yet another implementation, multiple designation rules, such as the first designation rule and the second designation rule, are applied to the transaction to generate multiple match scores. The respective match scores are compared to find the best match score. The match scores may also be compared with the match criterion to determine if any match is sufficient to associate a transaction designation to the transaction. Further, the designation rules may be applied to one or more additional transactions.

The method may include adding the designation rule to a register of designation rules. Further, the method may include incrementing a match counter counting the number of times the designation rule has matched a transaction. Still further, the method may include incrementing a selection counter counting the number of times the designation rule has been selected to designate a transaction.

FIG. 4 is a community-based transaction categorization flowchart 400 illustrating a method for generating new designation rules according to one implementation of the presently disclosed technology. The generation of a new designation rule may be by receiving and/or recording a new designation rule from a module of a transaction categorization system. First, an individual user within a community of users manually designates a transaction 405. The transaction may be manually designated because an existing individual and/or community rule does not generate a match score that meets a match criterion or multiple individual and/or community rules generate match scores that meet the match criterion and the transaction categorization system is unable to choose one rule with which to designate the transaction.

Once the transaction is manually designated, the transaction categorization system generates an individual rule that relates one or more attributes of the transaction to the user-selected designation. However, in one implementation, the user has an option to decline creating a new individual rule based on the manual transaction designation. Assuming an individual rule is created, the transaction categorization system next determines whether the individual rule is “promotable” to a community rule 415. An individual rule that is promotable to a community rule meets certain criteria designed to exclude individual rules from becoming community rules if their inclusion is not likely to enhance the community rule base. In one implementation, individual rules that relate to income are not promotable because income is highly personalized. For example, while an individual that works for a retailer (e.g., WALMART) may categorize transactions containing “WALMART” as “income”, most other users (i.e. users that do not work for WALMART) would likely categorize transactions containing “WALMART” differently.

In other implementations, the individual user may elect to make a new individual rule non-promotable due to the individual's personal knowledge that the individual rule would not enhance the community rule base or the user may have privacy concerns with promoting his/her designation preferences. Still further, a system administrator may manually check individual rules that are determined by the transaction categorization system to be promotable to community rules to ensure that promotion of the individual rules would indeed enhance the community rule base. The system administrator may also include an “omit list” in the transaction categorization system that automatically renders individual rules non-promotable based on one or more attributes of the transaction and/or corresponding individual rule.

If the individual rule is determined to be non-promotable, no new community rule is created 420. If the individual rule is promotable, it is then compared to the existing community rule base to determine if an already existing community rule is sufficiently similar to the promotable individual rule 425. If an existing community rule is sufficiently similar to the promotable individual rule, the existing community rule is adapted to incorporate the promotable individual rule 430. More specifically, a relevance factor of the existing community rule may be increased based on the number of promotable individual rules that are sufficiently similar to the community rule. Designation rules with a greater relevance factor may be applied to a transaction first or result in a larger match score

In another implementation, attributes and/or thresholds of the community rule are modified to incorporate the promotable individual rule. For example, a community rule holds that transactions with a name attribute containing “SAKS FIFTH AVENUE” are categorized clothing. A new individual rule holds that transactions with a name attribute containing “SAKS” are categorized clothing. The community rule may incorporate the new individual rule by adopting the broader test of a name attribute containing “SAKS” versus “SAKS FIFTH AVENUE” categorized as clothing.

If no existing community rule is sufficiently similar to the promotable individual rule, a new community rule based on the individual rule may be generated for the community 435. Similar to the tests cited above for determining whether an individual rule is promotable to a community rule, there may be more stringent tests for determining whether an individual rule is actually promoted to a community rule. Further, the system administrator may have the ability to go into the transaction categorization system and retroactively purge community rules that do not enhance the community rule base.

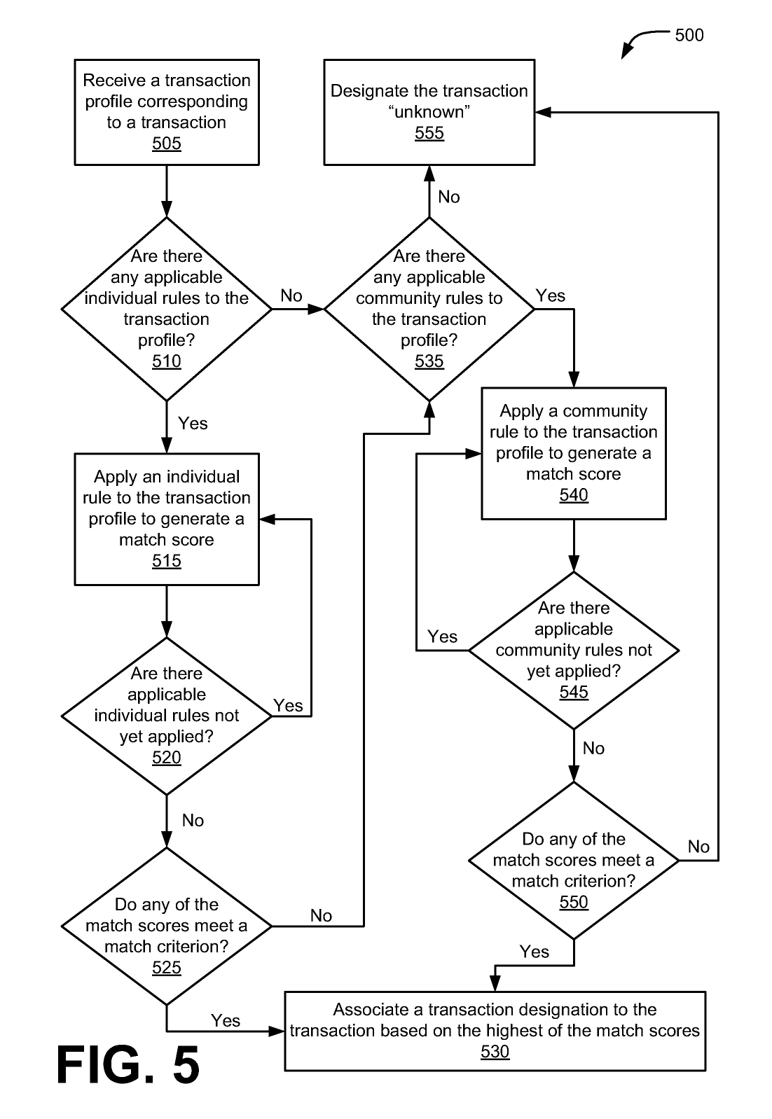

FIG. 5 is a community-based transaction categorization flowchart 500 illustrating a method for associating a transaction designation using individual rules and community rules according to one implementation of the presently disclosed technology. Similar to the method of FIG. 3, the transaction categorization system receives a transaction profile corresponding to a transaction 505.

The transaction categorization system then implements a query operation that determines if there are any applicable individual designation rules to the transaction profile 510. The transaction categorization system may require a transaction profile to share a minimum number of transaction attributes with the individual rule to apply the individual rule. If there are applicable individual rules, they are applied in succession 515 until the transaction categorization system determines that there are no more applicable individual rules not yet applied 520. For each individual rule, transaction attributes are iterated through and a transaction attribute score is generated for each transaction attribute. Further, the transaction attribute scores may be weighted. The resulting transaction attribute scores are combined (e.g. summed, averaged) to generate the match score for each individual rule applied to the transaction profile.

Once all the applicable individual rules are applied to the transaction profile, the resulting match scores are compared with a match criterion to determine if any of the match scores are sufficient (i.e. meet a match criterion) to apply a transaction designation to the transaction 525. If at least one of the resulting match scores meets the match criterion, the system associates a transaction designation to the transaction based on the highest of the match scores 530. If none of the match scores are sufficient to meet the match criterion or multiple match scores are equal (or in some implementations, nearly equal), the transaction categorization system then implements a query operation that determines if there are any applicable community designation rules to the transaction profile 535. Further, returning to query operation 510, if there are no applicable individual rules to the transaction profile, the system also implements the query operation 535.

If there are no applicable community rules to the transaction profile, the transaction is categorized as “unknown” and the user may be prompted to manually categorize the transaction if desired 555. If there are applicable community rules, they are applied in succession 540 until the transaction categorization system determines that there are no more applicable community rules not yet applied 545. For each community rule, transaction attributes are iterated through and a transaction attribute score is generated for each transaction attribute. Further, the transaction attribute scores may be weighted. The resulting transaction attribute scores are combined (e.g. summed, averaged) to generate the match score for each community rule applied to the transaction profile.

Once all the applicable community rules are applied to the transaction profile, the resulting match scores are compared with a match criterion to determine if any of the match scores are sufficient to apply a transaction designation to the transaction 550. If at least one of the resulting match scores meets the match criterion, the system associates a transaction designation to the transaction based on the highest of the match scores 530. If none of the match scores are sufficient to meet the match criterion or multiple match scores are equal (or in some implementations, nearly equal), the transaction is categorized as “unknown” and the user may be prompted to manually categorize the transaction if desired 555.

In some implementations, if the transaction categorization system associates a transaction designation based on a designation rule (e.g. a community or individual rule), a relevance factor for the designation rule is increased. A greater relevance factor improves the chance that application of the designation rule will result in a match score that meets or exceeds a match criterion. This allows designation rules that are used more frequently to be selected by the transaction categorization system more frequently for the designation of future transactions. In another implementation, the relevance factor of the designation rule is increased based number of times the designation rule is applicable to a transaction profile rather than the number of times the designation rule is actually used to associate a designation to a transaction. In further implementations, as the designation rule becomes older in the system and is not used frequently, its relevance factor decreases over time. On the contrary, as the designation rule becomes older in the system but continues to be used frequently, its relevance factor may increase over time.

Implementations of the transaction categorization system include functional modules or engines for carrying out the method steps described herein. Implementations of computer-readable media have computer-executable instructions that, when executed, cause a computer to carry out method steps described herein.

Some implementations of the presently disclosed technology utilize a matching algorithm to determine the best fit designation for an individual transaction. The algorithm generates a match score for a transaction with respect to each applicable designation rule. This process may be performed iteratively through all the designation rules. After the transaction has been evaluated against all designation rules, the designation rule that generates the best match score is utilized to associate a transaction designation to the transaction. In one implementation, the best match score must satisfy a match criterion (e.g. exceed a confidence threshold) to be considered applicable. If the best match score satisfies the match criterion, then the transaction will be designated according to the designation rule. If the best match score does not satisfy the match criterion, then the transaction will remain undesignated or designated “unknown”.

The scoring of a designation rule against the transaction is performed by combining (e.g. summing, averaging) scores on individual transaction attributes (e.g. textual, non-textual, and non-transactional) with a configurable weight applied to each attribute. The weighting enables specific attributes to contribute more or less to the match score.

Example textual transaction attributes that may be used in the scoring include, but are not limited to, payee name, transaction description, and any other words that directly describe the transaction. Payee name refers to the name of the entity with whom a user made a transaction. Transaction description refers to a description that the user may assign to the transaction at the time the transaction took place, e.g., the contents of the memo field of a paper check.

Further, non-textual transaction attributes (e.g. numeric information) may also be used in the scoring, including, but not limited to, transaction date, transaction amount, transaction type code, account type, payment method, recurrence period, and recurrence time. Transaction date refers to the date upon which the user made the transaction with the payee. Transaction amount refers to the amount of the transaction between the user and the payee. Transaction type code refers to a code assigned to a transaction that identifies the nature, purpose, and/or reason of the transaction, primarily used for regulatory reporting requirements. Account type refers to the user's funding source account for the transaction. Example account types include, but are not limited to, checking, savings, money market, credit card, and loan. Payment method refers to the type of payment used for the transaction. Example payment methods include, but are not limited to, cash, credit, and debit. Recurrence period refers to the period in which a transaction recurs. For example, rent is typically paid monthly and taxes are typically paid yearly. Additionally, recurrence time refers to the time of the week, month, and year, etc. in which a transaction recurs. For example, rent is typically paid at the beginning of each month and taxes are typically paid in April each year.

Additionally, non-transaction attributes may also be used in the scoring, including, but not limited to, demographic information, match count, select count, and any other information that may be used to associate transaction designations that does not relate to a specific transaction itself. Demographic information includes, but is not limited to race, sex, age, income, disabilities, mobility, education, home ownership, employment status, and location. Match count refers to the number of transactions, previously applied to a designation rule, that meet the requirements of the designation rule. Select count refers to the number of matched transactions, previously applied to a designation rule, that are actually designated as the designation rule suggests. A combination of match count and select count is referred to as a confidence score.

As discussed above, the presently disclosed technology contemplates both static and dynamic designations. While categories and transaction names are described with particularly herein, any static designation associated with a designation rule may be used to designate a transaction.

Further, the presently disclosed technology contemplates dynamic designations. A dynamic designation is not a fixed designation for a financial transaction but rather a pointer to a way of revising an aspect of a financial transaction. For example, a dynamic designation may point to a look up table for modifying an aspect of the transaction. In another example, a dynamic designation may point to a formula for cleansing the payee field of a financial transaction.

An implementation of a dynamic designation function checking for a best match using the payee name in a transaction profile is described below. This implementation utilizes a pattern generation and matching process rather than an SVM. Various parts of the following process are carried out by the modules and engines of the transaction categorization server 201 as shown in FIG. 2.

In this implementation, when a user manually designates a transaction, an individual rule is created that contains a payee name cleansing function for the payee name attribute field. This function is used for scoring the payee name attribute of the transaction. For example, an incoming transaction profile may have “The Chop House #1234 (29856)” in the payee name attribute field. The payee name cleansing function may be designed to: 1) truncate all characters from the payee name field after the occurrence of “(”; 2) truncate all characters from the payee name field after the occurrence of “<”; 3) truncate all characters from the payee name field after the occurrence of “'”; and/or 4) remove all dangling meta characters (e.g., replaces occurrences of “**” with “*”) from the payee name field.

The resulting pattern will then consist of one or more tokens. Here, the resulting pattern is “The Chop House #1234” and is composed of 4 tokens. Individual tokens in the payee name field are then omitted if they meet certain conditions. For example, the function may omit tokens if: 1) the token is only 1 character in length; 2) the token is one of the following: AND, OR, IS, OF, BY, THE, THIS, THAT, TO, FROM; and/or 3) the token consists of only numbers (e.g., 1234 or #1234).

The resulting pattern may then join the tokens with a “.*” between them to support the technique of using regular expressions (regex) within a Java Pattern class to determine a match. In the above example, the resulting pattern that is generated is “The.*Chop.*House.*”. Similarly, the cleansing function may be applied to any transaction attribute field that contains a string of words. As a result, when an incoming transaction profile has a payee name that matches a designation rule, after the payee name cleaning function is applied, a weighted score is applied for the payee name attribute field to the overall match score for the designation rule.

FIG. 6 is a screenshot of an example user interface for use in a community-based transaction categorization system according to various implementations of the presently disclosed technology. The user is presented with a list of expense categories on the left-hand side of the computer screen. These expense categories may have subcategories, sub-subcategories, and so on. The user is also presented with a list of uncategorized transactions with various transaction attributes associated with each transaction. Here, each transaction is accompanied with a transaction date, funding account, check number, transaction description, and amount. Further, the list of uncategorized transactions may be filtered to a date range or funding account.

The list of uncategorized transactions comprises transactions that the transaction categorization system does not yet know how to categorize. For example, the first time a transaction is input with a MARY KAY description attribute, the transaction categorization system may not know how to categorize the transaction. Thus the MARY KAY transaction is listed as uncategorized. The user may then manually select a category for this MARY KAY transaction. This selection may be made by any means of computer input; however, here the input is made by a “drag-and-drop” operation. The MARY KAY transaction is “dragged” from the uncategorized expenses list and “dropped” in the “Personal Care” category. To assist with this initial classification, the transaction categorization system may create an individual rule to group transactions based on common attributes. For example, if the uncategorized expenses list contained multiple MARY KAY transactions, dragging and dropping one MARY KAY transaction in the “Personal Care” category may cause all the MARY KAY transactions to automatically move to the “Personal Care” category. Alternatively, the transaction categorization system may prompt the user asking if it should classify all MARY KAY as “Personal Care.” The system may move only MARY KAY transactions that are not yet categorized, or alternatively, the system may retroactively re-categorize MARY KAY transactions according to the new system created individual rule. A user can thus very quickly categorize multiple similar transactions not yet learned by the application.

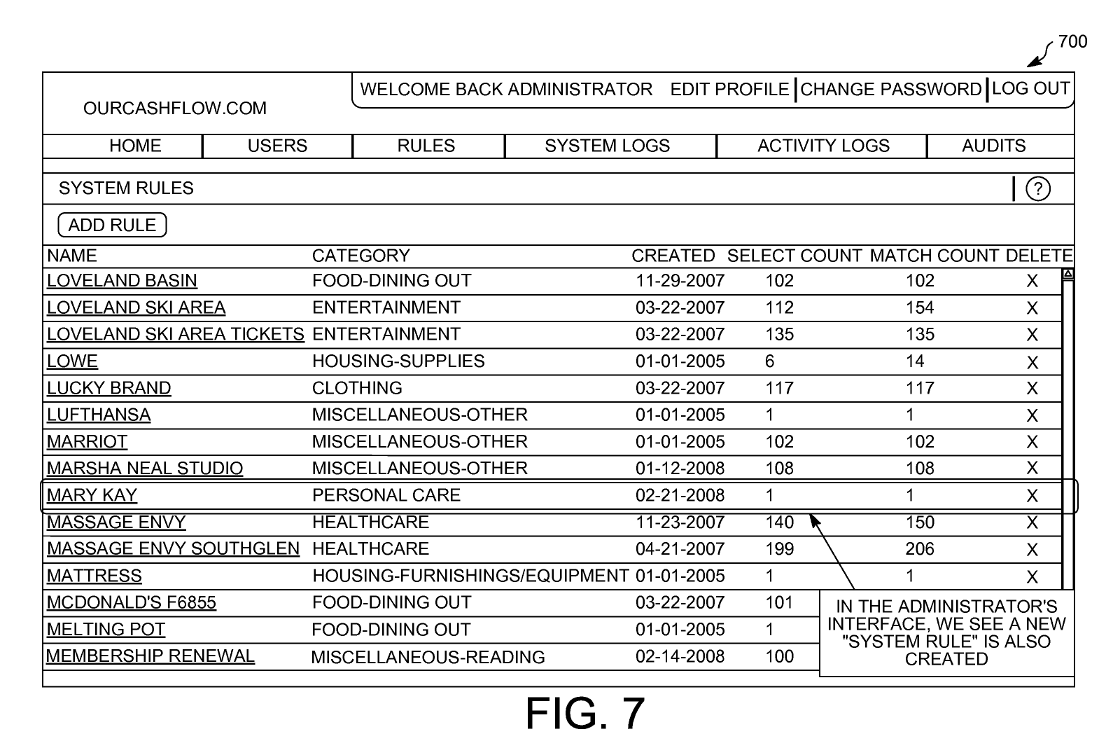

Referring now to FIG. 7, an administrator interface is shown. In the “Rules” section of the administrator interface, a list of system rules (including both individual rules and community rules) is shown. The system rules are listed by description and associated category along with a date created. The system rules also show statistics such as SELECT COUNT and MATCH COUNT. MATCH COUNT indicates the number of transactions that meet the requirements of the rule. SELECT COUNT indicates the number of matched transactions that are actually categorized as the rule suggests. The reason that the SELECT COUNT is less than the MATCH COUNT in some transaction descriptions (e.g. LOVELAND SKI AREA and MASSAGE ENVY) is due to manual categorization overriding the categorization rule or another categorization rule with a higher match score overriding the categorization rule with a lower match score. Referring to the MARY KAY rule, the system rule indicates that there is one MATCH COUNT and one SELECT COUNT showing that the individual rule created in FIG. 6 is the only rule referencing MARY KAY and is applied in only one instance.

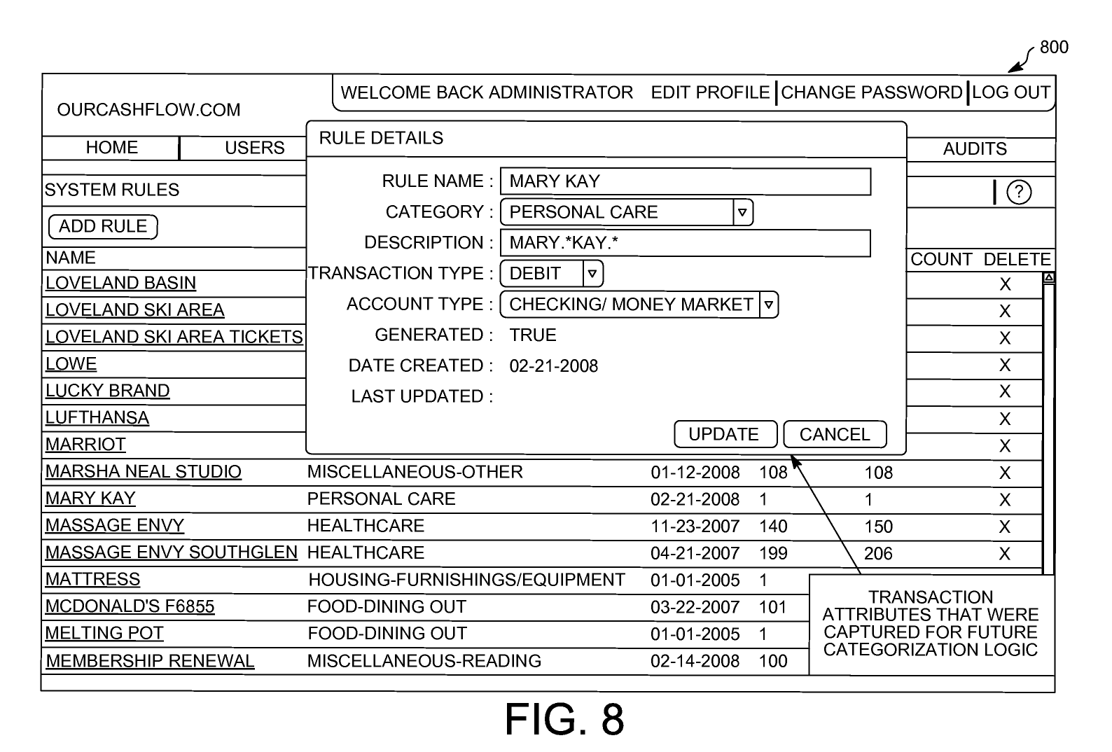

Further, the Administrator may select a specific system rule to view more information. In FIG. 7, the Administrator has selected MARY KAY to view additional information shown in FIG. 8. Referring now to FIG. 8, the description, MARY KAY, has been adopted as the rule name. The corresponding category, Personal Care is also shown along with the description, transaction type, funding account type, a generated field, the date created, and date the rule was last updated. A selection is available for the Administrator to update one or more categorization parameters for the system rule. The categorization parameters shown are examples only, additional categorization parameters include but are not limited to: payee name, transaction description, transaction date, transaction amount, transaction type code, account type, payment method, recurrence period, recurrence time, demographic information, match count, and select count. Further, an indication of whether the system rule is an individual rule and/or a community rule may be shown. If the system rule is an individual rule, the corresponding user may be identified as well.

After a short learning cycle, the system has the confidence to categorize all MARY KAY transactions as “Personal Care.” For example, even transactions with no description may be classified using other attributes including but not limited to payee name, amount of the transaction, and time of month when it is paid to learn categories.

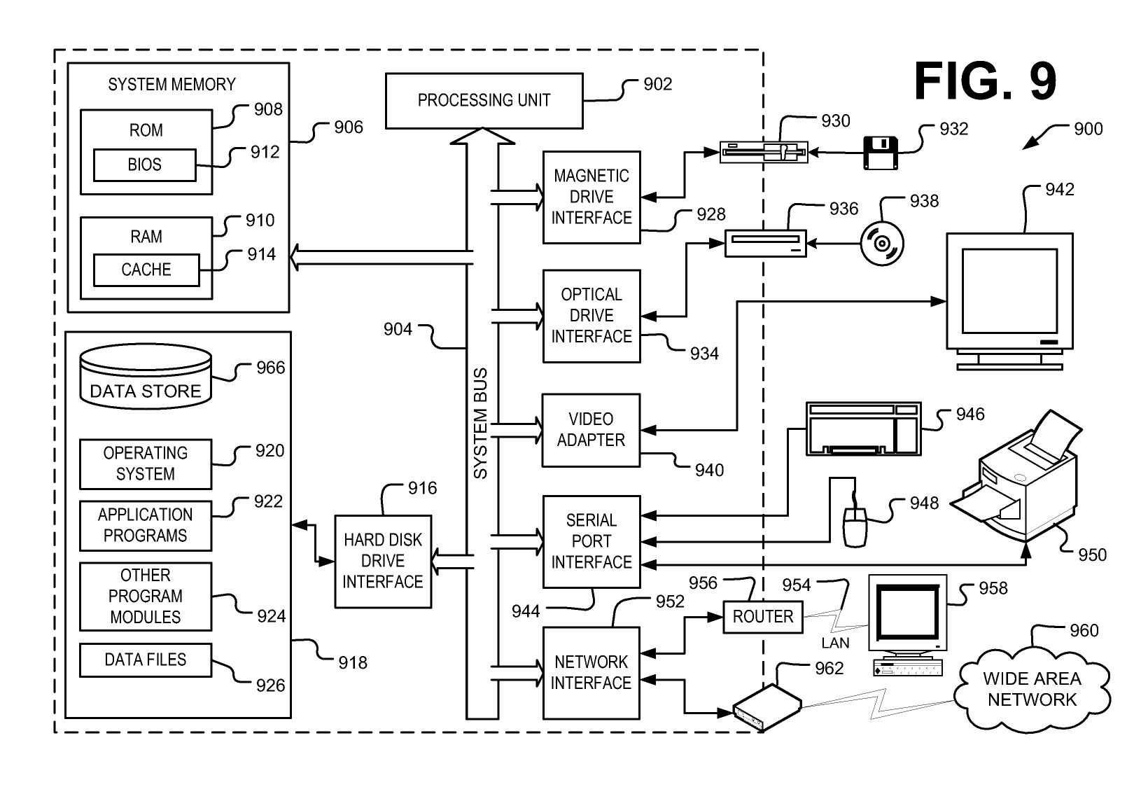

An example computer system 900 for implementing the matching, designating, categorizing, and naming processes above is depicted in FIG. 9. The computer system 900 may be in the form of server computers, personal computers (PC), or other special purpose computers with internal processing and memory components as well as interface components for connection with external input, output, storage, network, and other types of peripheral devices. Alternatively, the computer system 900 may be in the form of any of a notebook or portable computer, a tablet PC, a handheld media player (e.g., an MP3 player), a smart phone device, a video gaming device, a set top box, a workstation, a mainframe computer, a distributed computer, an Internet appliance, or other computer devices, or combinations thereof Internal components of the computer system in FIG. 9 are shown within the dashed line and external components are shown outside of the dashed line. Components that may be internal or external are shown straddling the dashed line.

The computer system 900 includes a processor 902 and a system memory 906 connected by a system bus 904 that also operatively couples various system components. There may be one or more processors 902, e.g., a single central processing unit (CPU), or a plurality of processing units, commonly referred to as a parallel processing environment. The system bus 904 may be any of several types of bus structures including a memory bus or memory controller, a peripheral bus, a switched-fabric, point-to-point connection, and a local bus using any of a variety of bus architectures. The system memory 906 includes read only memory (ROM) 908 and random access memory (RAM) 910. A basic input/output system (BIOS) 912, containing the basic routines that help to transfer information between elements within the computer system 900, such as during start-up, is stored in ROM 908. A cache 914 may be set aside in RAM 910 to provide a high speed memory store for frequently accessed data.

A hard disk drive interface 916 may be connected with the system bus 904 to provide read and write access to a data storage device, e.g., a hard disk drive 918, for nonvolatile storage of applications, files, and data. A number of program modules and other data may be stored on the hard disk 918, including an operating system 920, one or more application programs 922, other program modules 924, and data files 926. In an example implementation, the hard disk drive 918 may further store a registry of categorization rules and its corresponding modules. The hard disk drive 918 may additionally contain a data store 966 for maintaining the success and failure tables and other database server information described above. Note that the hard disk drive 918 may be either an internal component or an external component of the computer system 900 as indicated by the hard disk drive 918 straddling the dashed line in FIG. 9. In some configurations, there may be both an internal and an external hard disk drive 918.

The computer system 900 may further include a magnetic disk drive 930 for reading from or writing to a removable magnetic disk 932, tape, or other magnetic media. The magnetic disk drive 930 may be connected with the system bus 904 via a magnetic drive interface 928 to provide read and write access to the magnetic disk drive 930 initiated by other components or applications within the computer system 900. The magnetic disk drive 930 and the associated computer-readable media may be used to provide nonvolatile storage of computer-readable instructions, data structures, program modules, and other data for the computer system 900.

The computer system 900 may additionally include an optical disk drive 936 for reading from or writing to a removable optical disk 93 8 such as a CD ROM or other optical media. The optical disk drive 936 may be connected with the system bus 904 via an optical drive interface 934 to provide read and write access to the optical disk drive 936 initiated by other components or applications within the computer system 900. The optical disk drive 930 and the associated computer-readable optical media may be used to provide nonvolatile storage of computer-readable instructions, data structures, program modules, and other data for the computer system 900.

A display device 942, e.g., a monitor, a television, or a projector, or other type of presentation device may also be connected to the system bus 904 via an interface, such as a video adapter 940 or video card. Similarly, audio devices, for example, external speakers or a microphone (not shown), may be connected to the system bus 904 through an audio card or other audio interface (not shown).

In addition to the monitor 942, the computer system 900 may include other peripheral input and output devices, which are often connected to the processor 902 and memory 906 through the serial port interface 944 that is coupled to the system bus 906. Input and output devices may also or alternately be connected with the system bus 904 by other interfaces, for example, a universal serial bus (USB), a parallel port, or a FireWire (IEEE 994) port. A user may enter commands and information into the computer system 900 through various input devices including, for example, a keyboard 946 and pointing device 948, for example, a mouse. Other input devices (not shown) may include, for example, a microphone, a joystick, a game pad, a tablet, a touch screen device, a satellite dish, a scanner, a facsimile machine, and a digital camera, and a digital video camera. Other output devices may include, for example, a printer 950, a plotter, a photocopier, a photo printer, a facsimile machine, and a press (the latter not shown). In some implementations, several of these input and output devices may be combined into a single device, for example, a printer/scanner/fax/photocopier. It should also be appreciated that other types of computer-readable media and associated drives for storing data, for example, magnetic cassettes or flash memory drives, may be accessed by the computer system 900 via the serial port interface 944 (e.g., USB) or similar port interface.

The computer system 900 may operate in a networked environment using logical connections through a network interface 952 coupled with the system bus 904 to communicate with one or more remote devices. The logical connections depicted in FIG. 9 include a local-area network (LAN) 954 and a wide-area network (WAN) 960. Such networking environments are commonplace in home networks, office networks, enterprise-wide computer networks, and intranets. These logical connections may be achieved by a communication device coupled to or integral with the computer system 900. As depicted in FIG. 9, the LAN 954 may use a router 956 or hub, either wired or wireless, internal or external, to connect with remote devices, e.g., a remote computer 958, similarly connected on the LAN 954. The remote computer 958 may be another personal computer, a server, a client, a peer device, or other common network node, and typically includes many or all of the elements described above relative to the computer system 900.

To connect with a WAN 960, the computer system 900 typically includes a modem 962 for establishing communications over the WAN 960. Typically the WAN 960 may be the Internet. However, in some instances the WAN 960 may be a large private network spread among multiple locations. The modem 962 may be a telephone modem, a high speed modem (e.g., a digital subscriber line (DSL) modem), a cable modem, or similar type of communications device. The modem 962, which may be internal or external, is connected to the system bus 918 via the network interface 952. In alternate implementations the modem 962 may be connected via the serial port interface 944. It should be appreciated that the network connections shown are examples and other means of and communications devices for establishing a communications link between the computer system and other devices or networks may be used. Connection of the computer system 900 with a LAN 954 or WAN 960 allows an intelligent categorization application the ability to communicate with an administrator or remote community-based budgeting application similarly connected to the LAN 954 or WAN 960 to apply privately developed categorization rules to transactions generated by others in the community.

In an example implementation, a designation engine, transaction formatter, rule generator, rule filter, rule promoter, and other modules may be embodied by instructions stored in memory 906 and/or storage devices 932 or 938 and processed by the processing unit 902. Designation rules, transaction profiles, designated transactions reports, transaction report corrections, and other data may be stored in memory 906 and/or storage devices 932 or 938 as persistent datastores.

Although various implementations of presently disclosed technology have been described above with a certain degree of particularity, or with reference to one or more individual implementations, those skilled in the art could make numerous alterations to the disclosed implementations without departing from the spirit or scope of the presently disclosed technology. All directional references (e.g., proximal, distal, upper, lower, upward, downward, left, right, lateral, front, back, top, bottom, above, below, vertical, horizontal, clockwise, and counterclockwise) are only used for identification purposes to aid the reader's understanding of the presently disclosed technology, and do not create limitations, particularly as to the position, orientation, or use of the presently disclosed technology. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the basic elements of the presently disclosed technology.

The presently disclosed technology is implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the implementations of the technology described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of generating a set of community categorization rules applicable to financial transactions of users within a community, the method comprising:
receiving a user-defined designation for a first financial transaction of a first individual user of the community;
generating a first individual rule based on one or more transaction attributes of the first financial transaction and the user-defined designation, the first individual rule being applicable to one or more financial transactions of the first individual user; and
promoting the first individual rule for storage to a set of community rules using a processor, wherein the community rules are applicable to financial transactions of one or more other users within the community.

2. The method of claim 1, further comprising:
receiving transaction attributes specific to a second financial transaction;
applying a community rule within the set of community rules to the transaction attributes to generate a first match score using the processor; and
associating a transaction designation with the second financial transaction according to the applied community rule if the first match score satisfies a match criterion using the processor.

3. The method of claim 1, further comprising:
receiving transaction attributes specific to a second financial transaction;
applying a first community rule within the set of community rules to the transaction attributes to generate a first match score using the processor;
applying a second community rule within the set of community rules to the transaction attributes to generate a second match score using the processor;
associating a transaction designation with the second financial transaction according to the first community rule if the first match score exceeds the second match score and satisfies the match criterion using the processor; and
associating a transaction designation with the second financial transaction according to the second community rule if the second match score exceeds the first match score and satisfies the match criterion using the processor.

4. The method of claim 1, further comprising:
receiving transaction attributes specific to a second financial transaction;
applying a second individual rule applicable to a second individual user to the transaction attributes to generate a first match score using the processor;
associating a first transaction designation with the second financial transaction according to the second individual rule if the first match score satisfies a match criterion using the processor;
applying a community rule within the set of community rules to the transaction attributes to generate a second match score if the first match score does not satisfy the match criterion using the processor; and
associating a second transaction designation with the second financial transaction according to the applied community rule if the second match score satisfies the match criterion using the processor.

5. The method of claim 1, further comprising:
applying a community rule within the set of community rules to a previously designated financial transaction to generate a first match score using the processor; and
associating a new transaction designation with the second financial transaction according to the applied community rule if the first match score satisfies a match criterion using the processor.

6. The method of claim 1, further comprising:
determining whether the first individual rule is promotable to the set of community rules.

7. The method of claim 1, wherein the promoting operation includes:
determining if a community rule similar to the first individual rule already exists in the set of community rules; and
adapting the similar community rule to incorporate the first individual rule, if the similar community rule exists.

8. The method of claim 1, wherein the promoting operation includes:
determining if a community rule similar to the first individual rule already exists in the set of community rules; and
increasing a relevance factor associated with the similar community rule, if the similar community rule exists.

9. The method of claim 1, wherein the promoting operation includes
generating a new community rule from the first individual rule.

10. The method of claim 1, wherein the user-defined designation includes income and the first individual rule is not promotable to the set of community rules.

11. The method of claim 1, wherein the user-defined designation includes a user-created category and the first individual rule is not promotable to the set of community rules.

12. A system for generating a set of community categorization rules applicable to financial transactions of users within a community, the system comprising:
a network interface that receives a user-defined designation for a first financial transaction of a first individual user of the community;
one or more storage media that stores the user-defined designation, a first individual rule, and a set of community rules; and
a processor that generates the first individual rule based on one or more transaction attributes of the first financial transaction and the user-defined designation, the first individual rule being applicable to one or more financial transactions of the first individual user, wherein the processor further promotes the first individual rule to the set of community rules, wherein the community rules are applicable to financial transactions of one or more other users within the community.

13. The system of claim 12, wherein the network interface further receives transaction attributes specific to a second financial transaction and the processor further applies a community rule within the set of community rules to the transaction attributes to generate a first match score and associates a transaction designation with the second financial transaction according to the applied community rule if the first match score satisfies a match criterion.

14. The system of claim 12, wherein the network interface further receives transaction attributes specific to a second financial transaction and the processor further applies a first community rule within the set of community rules to the transaction attributes to generate a first match score, applies a second community rule within the set of community rules to the transaction attributes to generate a second match score, associates a transaction designation with the second financial transaction according to the first community rule if the first match score exceeds the second match score and satisfies the match criterion, and associates a transaction designation with the second financial transaction according to the first community rule if the first match score exceeds the second match score and satisfies the match criterion.

15. The system of claim 12, wherein the network interface further receives transaction attributes specific to a second financial transaction and the processor further applies a second individual rule applicable to a second individual user to the transaction attributes to generate a first match score, associates a first transaction designation with the second financial transaction according to the second individual rule if the first match score satisfies a match criterion, applies a community rule within the set of community rules to the transaction attributes to generate a second match score if the first match score does not satisfy the match criterion, and associates a second transaction designation with the second financial transaction according to the applied community rule if the second match score satisfies the match criterion.

16. The system of claim 12, wherein the processor further applies a community rule within the set of community rules to a previously designated financial transaction to generate a first match score and associates a new transaction designation with the second financial transaction according to the applied community rule if the first match score satisfies a match criterion.

17. The system of claim 12, wherein the processor further determines whether the first individual rule is promotable to the set of community rules.

18. The system of claim 12, wherein the processor further determines if a community rule similar to the first individual rule already exists in the set of community rules and adapts the similar community rule to incorporate the first individual rule, if the similar community rule exists.

19. The system of claim 12, wherein the processor further determines if a community rule similar to the first individual rule already exists in the set of community rules and increases a relevance factor associated with the similar community rule, if the similar community rule exists.

20. The system of claim 12, wherein the processor further generates a new community rule from the first individual rule.

21. The system of claim 12, wherein the user-defined designation includes income and the first individual rule is not promotable to the set of community rules.

22. The system of claim 12, wherein the user-defined designation includes a user-created category and the first individual rule is not promotable to the set of community rules.

23. A computer-readable medium storing computer-readable instructions for generating a set of community categorization rules applicable to financial transactions of users within a community, wherein the instructions comprise operations to:
receive a user-defined designation for a first financial transaction of a first individual user of the community;
generate a first individual rule based on one or more transaction attributes of the first financial transaction and the user-defined designation, the first individual rule being applicable to one or more financial transactions of the first individual user; and
promote the first individual rule for storage to a set of community rules, wherein the community rules are applicable to financial transactions of one or more other users within the community.

24. The computer readable medium of claim 23, wherein the instructions further comprise operations to:
receive transaction attributes specific to a second financial transaction;
apply a community rule within the set of community rules to the transaction attributes to generate a first match score; and
associate a transaction designation with the second financial transaction according to the applied community rule if the first match score satisfies a match criterion.

25. The computer readable medium of claim 23, wherein the instructions further comprise operations to:
receive transaction attributes specific to a second financial transaction;
apply a first community rule within the set of community rules to the transaction attributes to generate a first match score;
apply a second community rule within the set of community rules to the transaction attributes to generate a second match score;
associate a transaction designation with the second financial transaction according to the first community rule if the first match score exceeds the second match score and satisfies the match criterion; and
associate a transaction designation with the second financial transaction according to the second community rule if the second match score exceeds the first match score and satisfies the match criterion.

26. The computer readable medium of claim 23, wherein the instructions further comprise operations to:
receive transaction attributes specific to a second financial transaction;
apply a second individual rule applicable to a second individual user to the transaction attributes to generate a first match score;
associate a first transaction designation with the second financial transaction according to the second individual rule if the first match score satisfies a match criterion;
apply a community rule within the set of community rules to the transaction attributes to generate a second match score if the first match score does not satisfy the match criterion; and
associate a second transaction designation with the second financial transaction according to the applied community rule if the second match score satisfies the match criterion.
